(19) United States
(12) Patent Application Publication
(10) Pub. No.: US 2015/0352878 A1
(43) Pub. Date: Dec. 10, 2015

(54) PRINTING STEEL PLATE HAVING STRESS DISPERSION STRUCTURE

(71) Applicant: FAITHFUL PRINTING EQUIPMENT & SUPPLY CO., LTD., New Taipei City (TW)

(72) Inventor: Yi-Yang LIN, New Taipei City (TW)

(21) Appl. No.: 14/728,858

(22) Filed: Jun. 2, 2015

(30) Foreign Application Priority Data
Jun. 10, 2014 (TW) 103210170

(51) Int. Cl. B41N 1/00

(52) U.S. Cl. CPC B41N 1/00

(57) ABSTRACT

A printing steel plate having a stress dispersion structure. Along a printing direction, at least one stress dispersion structure is additionally arranged on each of two sides adjacent to a plurality of blanking holes arranged into a pattern of a printed subject on the printing steel plate, the stress dispersion structure is formed by a plurality of stress buffer holes, and the stress buffer holes are visible holes that cannot be penetrated by ink on the printing steel plate. The stress buffer holes are used to disperse a deformation phenomenon of structures of peripheral blanking holes of the formed pattern on the printing steel plate caused by the pulling of stress, which effectively restrains the deformation of the structures of the peripheral blanking holes of the pattern

### CROSS-REFERENCE TO RELATED APPLICATION

This application claims the benefit of Taiwan Patent Application No. 103210170, filed on Jun. 10, 2014, which is hereby incorporated by reference for all purposes as if fully set forth herein.

### BACKGROUND

1. Technical Field

The present invention relates to a printing steel plate, and in particular, to a structural design of a printing stencil with a printing steel plate having a stress dispersion structure.

2. Related Art

For a structure of a stencil of a printing steel plate, a first type of the structure mainly includes a frame body, a supporting network disposed on internal edges of the frame body, and a printing steel plate disposed on the supporting network, the printing steel plate being provided with a plurality of blanking holes arranged in a shape to be printed; a second type of the structure is a full steel plate structure, including a frame body and a printing steel plate. In implementation, the metal stencil covers a substrate, printing sizing materials are placed on the printing steel plate, and the sizing materials are scraped into the blanking holes by a scraper, so that the sizing materials are adhered to the substrate through the blanking holes to be printed into a form.

An opening (the blanking hole) on the printing steel plate is formed mainly in the following manners: 1. chemical etching; 2. laser cutting; 3. electro forming. In implementation, it is not limited to the foregoing three forming manners, different forming manners of the opening have different applications, and quality of the opening on the printing steel plate determines a yield rate of the product in the future.

However, for the printing steel plate, different manufacturing manners may affect the printing quality; in addition, the magnitude of tension is also an important variable and may reduce with the increase of printing frequency and using time, and therefore, it is an indispensable work to check the tension of the steel plate regularly. In addition, selection of a steel plate with a proper thickness may also have a beneficial effect on the improvement of the printing quality, and at present, a general specification used in the industry is about between 0.08 mm-0.25 mm.

For the tension of the printing steel plate, a current printing mode for a positive silver electrode of a solar cell is used as an example. One of the printing is screen printing, including printing a complete bus; the second is steel printing, including printing a structure of a complete continuous finger electrode; and in the printing, sequences of the process may be selected according to a practical application requirement of a solar cell.

Referring to FIG. 1, a printing steel plate 10 for a finger electrode is used as an example for description. The printing steel plate 10 has blanking holes 11 in patterns of finger electrodes. When a scraper (not shown in the figure) scrapes sizing materials into the blanking holes 11 along a printing direction 20, because the structure of peripheral blanking holes 11a in patterns of finger electrodes on the printing steel plate 10 may deform or warp under pulling of stress 30 on two sides, precision of fitting of the patterns, and the appearance and pattern completeness (as shown in FIG. 2) of printed subjects 41 (finger electrodes) actually printed on a substrate 40 may be affected directly or indirectly, and in the printing process, phenomena such as splash, diffusion, and uneven thickness of the sizing materials may occur on the printed subjects 41a on the two edges, which directly or indirectly affects the completeness of the printed subject and the precision of the fitting.

For the existing printing steel plate without a pattern bearing body, structural tension of an external side of the printing steel plate is insufficient because of a continuous or an interrupted pattern design, which results in deformation and warping of the peripheral patterns on the printing steel plate after a long time; and in more cases, because the scraper directly exerts stress on the printing steel plate in the printing process, leading to pulling of the stress, edges of the peripheral patterns on the printing steel plate cannot maintain a steady and normal pattern design, and then the peripheral patterns on the printing steel plate deform or warp. As a result, such a steel plate cannot be put into mass production successfully.

### SUMMARY

To prevent the foregoing defects, an objective of the present invention is to provide a printing steel plate having a stress dispersion structure. By using such a structure, a deformation phenomenon of structures of peripheral blanking holes of the formed pattern on the printing steel plate caused by the pulling of stress is dispersed, which effectively restrains the deformation of the structures of the peripheral blanking holes of the pattern, and avoids phenomena such as sizing materials splash, diffusion, and uneven thickness on two sides of the edge of a subject caused by printing in the printing process, so that the following effect is achieved: in the printed subject, an external side and an internal side have same patterns, uniform and effective thin line widths with the same line width, a high aspect ratio, and highly precise fitting.

To achieve the foregoing objective, the present invention is directed to a printing steel plate having a stress dispersion structure, which is a structure of a printing steel plate applied to a stencil of the printing steel plate. Along a printing direction, at least one stress dispersion structure is additionally arranged on each of two sides adjacent to a plurality of blanking holes arranged into patterns of a printed subject on the printing steel plate, the stress dispersion structure is formed by a plurality of stress buffer holes, and the stress buffer holes are visible holes that cannot be penetrated by ink on the printing steel plate. The stress buffer holes are used to disperse stress on the two sides generated during the printing, and restrain a deformation phenomenon of structures of the peripheral blanking holes of a formed pattern on the printing steel plate caused by the pulling of the stress.

The stress buffer holes of the stress dispersion structure are arranged in one of the following manners: an in-line arrangement manner, a transverse arrangement manner, an alternate arrangement manner, and a combination of the foregoing arrangement manners. The shape of the patterns of the stress buffer holes is one of a linear shape, a round hole shape, a triangular shape, a rectangular shape, and a combination of the foregoing shapes; further, a maximum length of the shape of the patterns of the stress buffer holes is not limited to a maximum length of the pattern of the printed subject on the printing steel plate.

Filling materials are disposed in the stress buffer holes, the filling materials are one of adhesive, high polymer materials, resin, and a combination of the foregoing materials, or, surfaces of one of upper layers, lower layers, and the upper lower layers are covered with fixing tape, so that the stress buffer holes are visible but cannot be penetrated by ink.

The advantage of the present invention is that, at least one stress dispersion structure is additionally arranged on each of the two sides adjacent to a plurality of blanking holes arranged into patterns of a printed subject on the printing steel plate, the stress dispersion structure is formed by a plurality of stress buffer holes, and the stress buffer holes are visible holes that cannot be penetrated by ink on the printing steel plate; the stress buffer holes are used to disperse the stress directly exerted on the printing steel plate by a scraper in the printing process, so as to restrain the deformation phenomenon of the structures of the peripheral blanking holes of the formed pattern on the printing steel plate caused by the pulling of the stress, and effectively restrain deformation of the structures of the peripheral blanking holes of the pattern. Therefore, the following effect is achieved: in the printed subject, an external side and an internal side have same patterns, uniform and effective thin line widths with the same line width, a high aspect ratio, and highly precise fitting.

### BRIEF DESCRIPTION OF THE DRAWINGS

The disclosure will become more fully understood from the detailed description given herein below for illustration only, and thus are not limitative of the disclosure, and wherein:

FIG. 1 is a schematic diagram of force on a printing steel plate in the prior art;

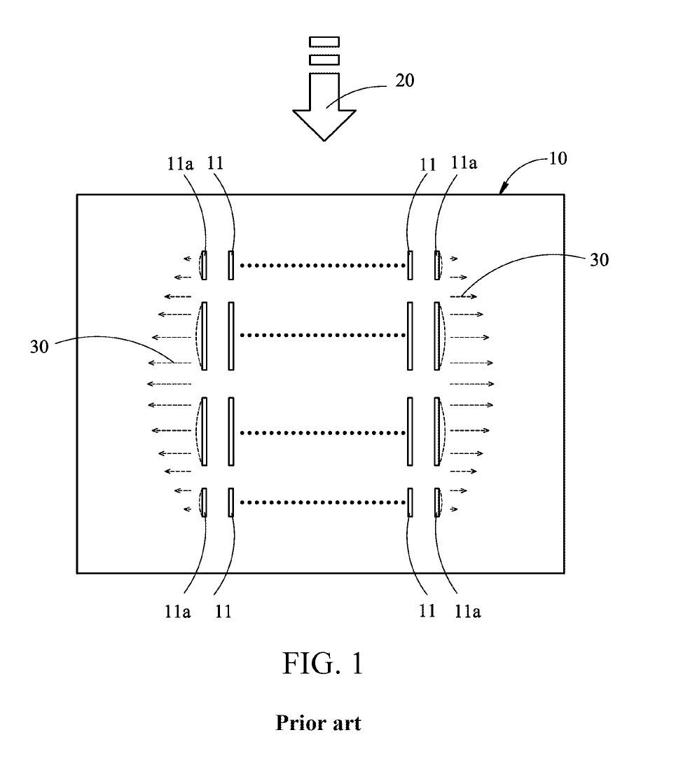

FIG. 2 is a schematic diagram of printed-forming by the printing steel plate in FIG. 1;

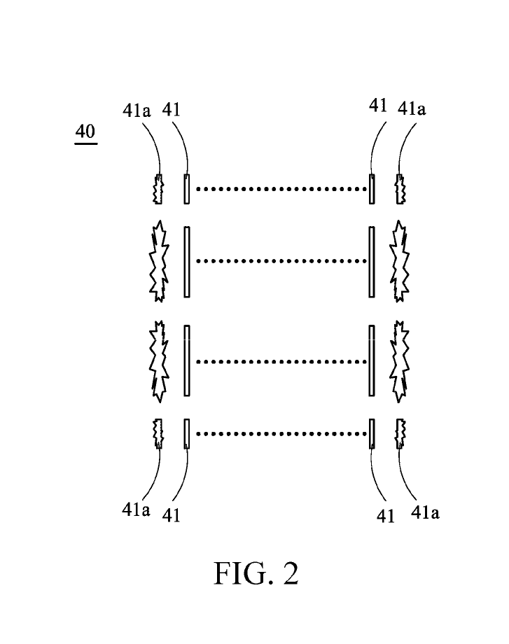

FIG. 3 is a first schematic diagram of a structure and force of a printing steel plate according to an embodiment of the present invention;

FIG. 4 is a schematic diagram of printed-forming by the printing steel plate in FIG. 3;

FIG. 5 is a second schematic diagram of a structure and force of a printing steel plate according to an embodiment of the present invention;

FIG. 6 is a third schematic diagram of a structure and force of a printing steel plate according to an embodiment of the present invention;

FIG. 7 is a fourth schematic diagram of a structure and force of a printing steel plate according to an embodiment of the present invention; and

FIG. 8 is a fifth schematic diagram of a structure and force of a printing steel plate according to an embodiment of the present invention.

### DETAILED DESCRIPTION

Detailed content and technical descriptions related to the present utility model are further described below by using embodiments, but it should be understood that the embodiments are only used as examples for description, and should not be construed as a limit to the present utility model.

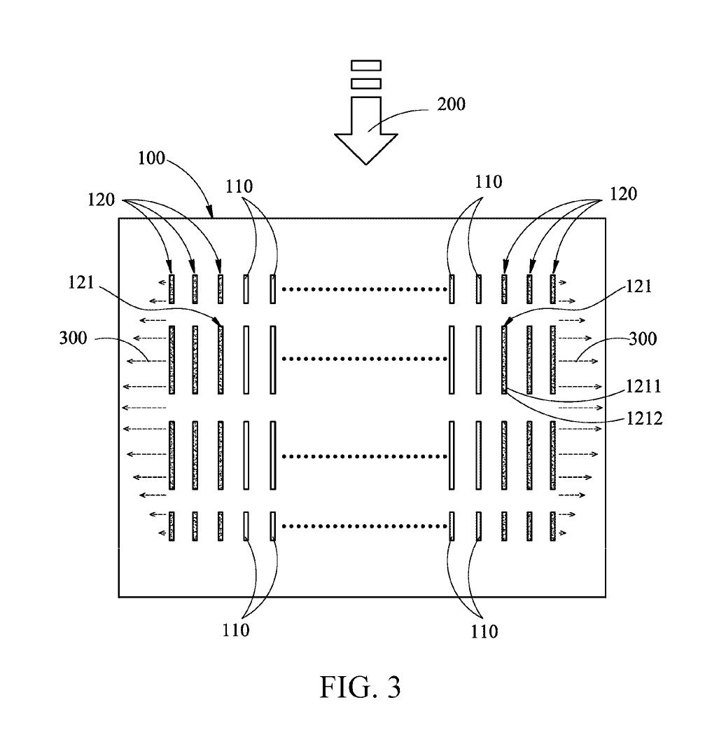

FIG. 3 is a first schematic diagram of a structure and force of a printing steel plate according to an embodiment of the present invention. The invention discloses a printing steel plate having a stress dispersion structure, which is a structure of a printing steel plate 100 (the printing steel plate 100 for a finger electrode is used as an example for description in the drawings of this embodiment) applied to a stencil of a printing steel plate. Along a printing direction 200, at least one stress dispersion structure 120 (three stress dispersion structures are used as an example for description in the figure) is additionally arranged on each of two sides adjacent to a plurality of blanking holes 110 arranged into a pattern of a printed subject on the printing steel plate 100, the stress dispersion structure 120 is formed by a plurality of stress buffer holes 121, and the stress buffer holes 121 are visible holes 1211 that cannot be penetrated by ink on the printing steel plate 100.

In implementation, filling materials 1212 are disposed in holes 1211 of the stress buffer holes 121, and the filling materials 1212 are one of adhesive, high polymer materials, resin, and a combination of the foregoing materials, so that the stress buffer holes 121 are visible but cannot be penetrated by ink.

Alternatively, surfaces of one of upper layers, lower layers, and the upper and lower layers of the stress buffer holes 121 of the stress dispersion structure 120 are covered with fixing tape instead of the foregoing filling materials 1212, so as to seal the holes 1211 of the stress buffer holes 121, so that the stress buffer holes 121 are visible holes that cannot be penetrated by ink. The fixing tape covered on the surfaces may be ordinary tape, silver dragon tape, special tape, or other associated materials for covering and being pasted on a surface, which all fall within the implementation scope.

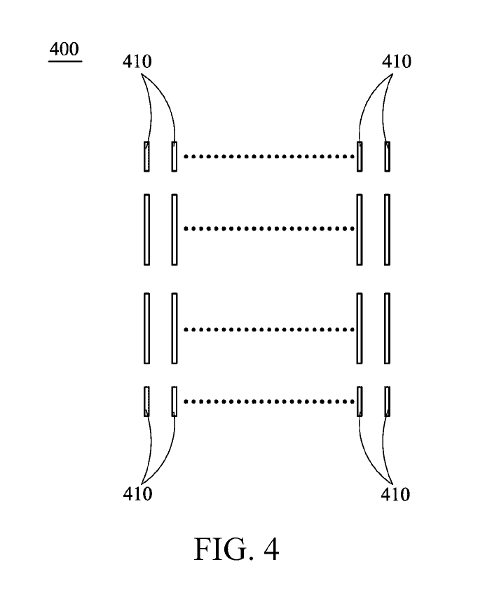

The stress dispersion structure 120 that is formed by the stress buffer holes 121 on each of the two sides adjacent to the blanking holes 110 arranged into a pattern on the printing steel plate 100 is used, so that after a scraper (not shown in the figure) scrapes sizing materials (not shown in the figure) along the printing direction 200 into the blanking holes 100, stress 300 on the two sides caused by the press of the scraper is effectively dispersed by the filling materials 1212 in the stress buffer holes 121, so as to restrain the deformation phenomenon of the structures of the peripheral blanking holes 110 of the formed pattern on the printing steel plate 100 caused by the pulling of the stress 300 resulted from the press of the scraper, and effectively restrain deformation of the structures of the peripheral blanking holes 110 of the pattern. Therefore, the following effect is achieved: in each printed subject 410 (a finger electrode is used as an example for description) actually printed on a substrate 400, an external side and an internal side have same patterns, uniform and effective thin line widths with the same line width, a high aspect ratio, and highly precise fitting (as shown in FIG. 4).

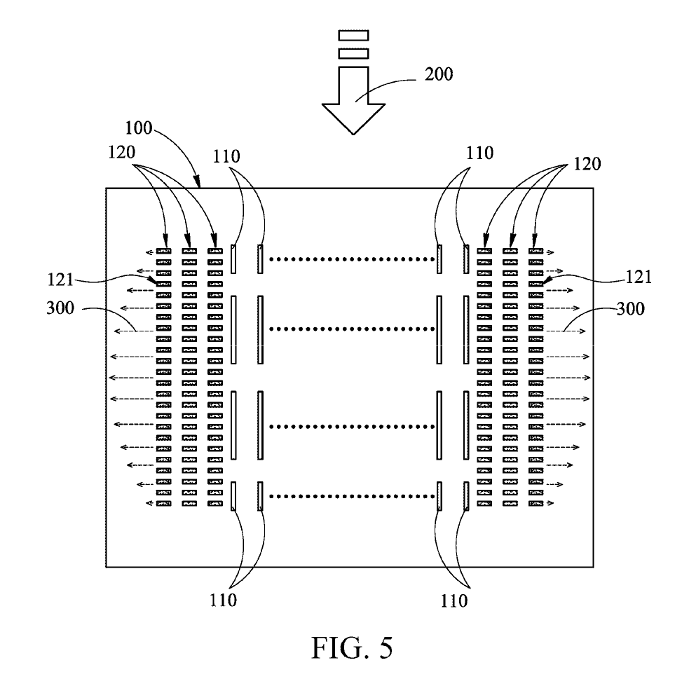

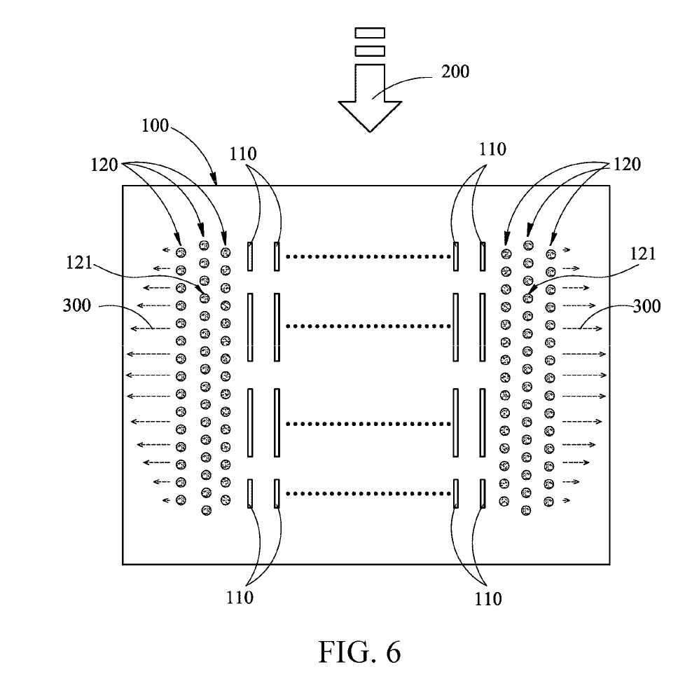

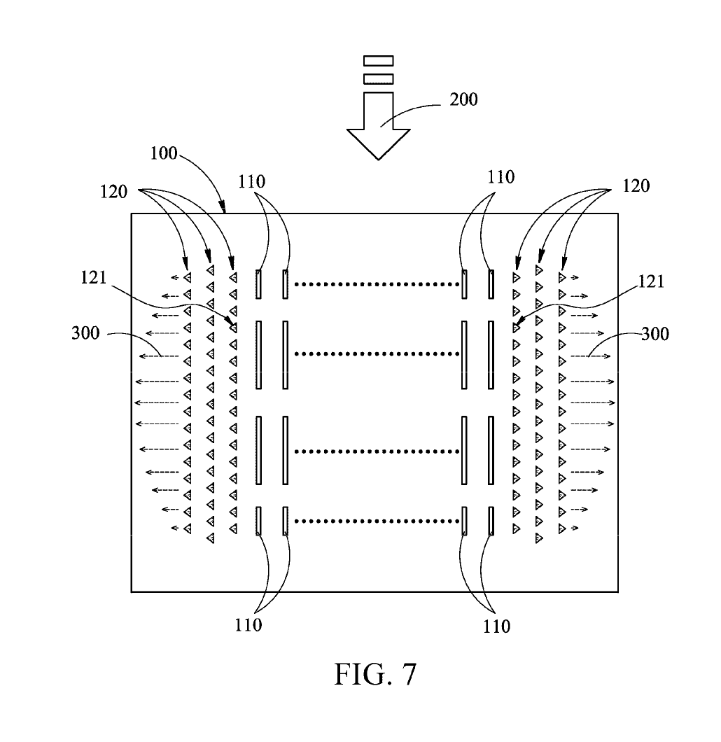

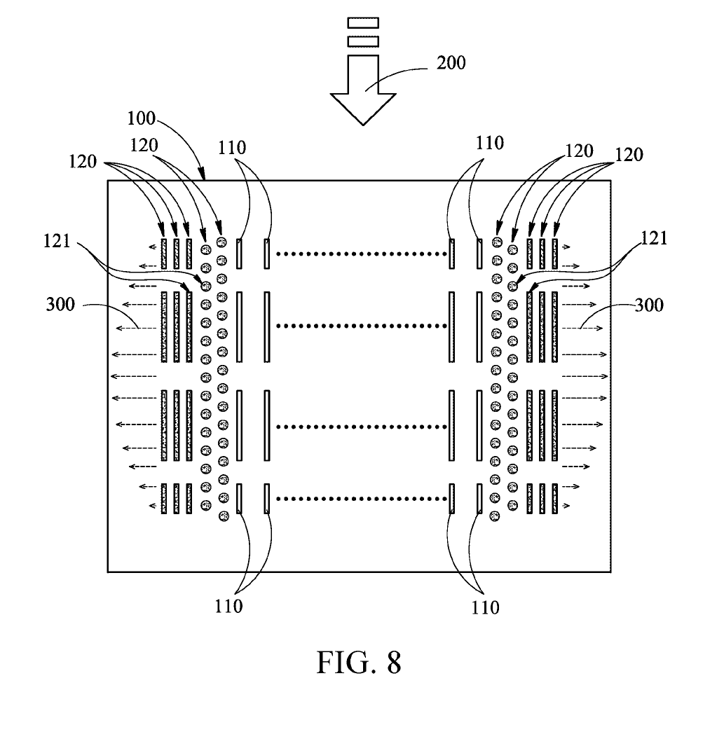

The stress buffer holes 121 of the stress dispersion structure 120 are arranged in one of the following manners: an in-line arrangement manner (as shown in FIG. 3), a transverse arrangement manner (as shown in FIG. 5), an alternate arrangement manner (as shown in FIG. 6 and FIG. 7), and a combination of the foregoing manners (as shown in FIG. 8, which is a combination of FIG. 3 and FIG. 6).

Further, in an optimal embodiment, a maximum length of the shape of the patterns of the stress buffer holes 121 is not greater than a maximum length of the blanking holes 110 of the pattern of the printed subject on the printing steel plate 100, so that the stress dispersion effect of the stress buffer holes 121 can effectively restrain the deformation of the structures of the blanking holes 110. The shape of the patterns of the stress buffer holes 121 is one of a linear shape (as shown in FIG. 3), a round hole shape (as shown in FIG. 6), a triangular shape (as shown in FIG. 7), a rectangular shape (as shown in FIG. 5), and a combination of the foregoing shapes (as shown in FIG. 8, which is a combination of the linear shape and the round hole shape).

The foregoing descriptions are merely preferred embodiments of the present utility model, and are not intended to limit the scope of the present utility model, that is simple equivalent variations and modifications made according to the scope of the patent application of the present utility model and the description content of the present utility model all fall within the scope of the present utility model.

What is claimed is:

1. A printing steel plate having a stress dispersion structure, which is a structure of a printing steel plate applied to a stencil of the printing steel plate, characterized in that:
along a printing direction, at least one stress dispersion structure is additionally arranged on each of two sides adjacent to a plurality of blanking holes arranged into a pattern of a printed subject on the printing steel plate, the stress dispersion structure is formed by a plurality of stress buffer holes, and filling materials are disposed in the stress buffer holes, so that the stress buffer holes are visible holes that cannot be penetrated by ink on the printing steel plate.

2. The printing steel plate having a stress dispersion structure of claim 1, wherein the shape of the patterns of the stress buffer holes is one of a linear shape, a round hole shape, a triangular shape, a rectangular shape, and a combination of the foregoing shapes.

3. The printing steel plate having a stress dispersion structure of claim 2, wherein a maximum length of the shape of the patterns of the stress buffer holes is not limited to a maximum length of the pattern of the printed subject on the printing steel plate.

4. The printing steel plate having a stress dispersion structure of claim 1, wherein the stress buffer holes of the stress dispersion structure are arranged in one of the manners: an in-line arrangement manner, a transverse arrangement manner, an alternate arrangement manner, and a combination of the foregoing arrangement manners.

5. The printing steel plate having a stress dispersion structure of claim 1, wherein filling materials are disposed in the stress buffer holes, and the filling materials are one of adhesive, high polymer materials, resin, and a combination of the foregoing materials so that the stress buffer holes are visible but cannot be penetrated by ink.

6. The printing steel plate having a stress dispersion structure of claim 1, wherein surfaces of one of upper layers, lower layers, and the upper lower layers of the stress buffer holes are covered with a fixing tape, so that the stress buffer holes are visible but cannot be penetrated by ink.
